(19) United States
(12) Patent Application Publication
(10) Pub. No.: US 2005/0060289 A1
(43) Pub. Date: Mar. 17, 2005

(54) A method for relaxing multiple constraints in search and calculation and then displaying results

(76) Inventors: Mark Keenan, San Carlos, CA (US); Anthony Mirante, Piedmont, CA (US); Nathon Huebner, St. Louis, MO (US)

Correspondence Address: JEFFREY FURR, 253 N. MAIN STREET, JOHNSTOWN, OH, 43031, US

(21) Appl. No.: 10/605,186

(22) Filed: Sep. 12, 2003

(51) Int. Cl. G06F 7/00

(52) U.S. Cl. 707/3

(57) ABSTRACT

A method and process for refining a search or calculation query with multiple constraints via the Internet. The search is initiated by an end-user at a client system (Client) and received by a server system or group of server systems (Server). The Server receives the search query that includes multiple constraints. The Server then responds may to the query with data that meets these constraints or responds with a set of refined constraints for the query. The client system then presents the end user with a number of new queries that the user may use to refine their search.

### BACKGROUND OF INVENTION

1. Field of the Invention

The present invention relates to a computer method and process for performing a search query and, more particularly refining that search over the Internet.

2. Description of Prior Art

The Internet comprises a vast number of computers and computer networks that are interconnected through communication links. One of the primary uses of the Internet is to search for information or to perform calculations. Users may perform these computations to gather information; they may do so to facilitate the sale of products and services or they may do so for other reasons.

When a user performs a search or calculation on the Internet, they create a set of constraints. This may be only one simple constraint such as a search for one keyword, “car”, for example, or it may be a complex query. In the case of a complex query the search could involve a number of search constraints. An example of looking for information where there are several constraints could be looking for a “red car”. One constraint being the information include the keyword “car” and the second constraint being that the information include the keyword “red”.

Performing these searches/calculations is one of the most common tasks end users perform when using the Internet. The results of many search queries can be fruitless for end-users. The end user may get too many results, making the results difficult to analyze. They may get no results. Results may not inform the end user how to refine their search query such that the results have more utility. Also the actions required of the end-user to refine and perform a new search query can be cumbersome. It may require the end-user to retype or select new constraints.

There is still need for improvement in the art.

### SUMMARY OF INVENTION

An embodiment of the present invention provides a method and process for refining a search query and performing a new query. This system is used during search queries in cases where there are too many search results, no search results or the results are otherwise inappropriate. When this is the case the system presents the user with options that would either relax or tighten the query constraints, and presents the end user with data about these alternative search queries. The end user may elect to perform one of these refined search queries with one action such as a click of a mouse or selection key.

This method and process for refining the constraints of a search or calculation gives end users results in a format that makes it easier to analyze, and with minimal work refine the search query.

A primary object of the present invention is to refine a search query and either perform a new query or display modified results from the search query.

Other objectives and advantages of the present invention will become obvious to the reader and it is intended that these objectives and advantages are within the scope of the present invention.

To accomplish the above and related objectives, this invention may be embodied in the form illustrated in the accompanying drawings, attention being called to the fact, however, that the drawings are illustrative only, and that changes may be made in the specific construction illustrated.

Definitions:

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

Query: It can be a search query or a calculation or a product configuration.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

Visit: a series of requests to a fixed Web server by a single person (through a browser), occurring contiguously in time.

Web master: the (typically technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows an overview of how a User and Service provider accesses the system through the Internet;

FIG. 2 displays an example of end user screen for a “parametric search” for magnetic circuit breakers;

FIG. 3a displays an overview flowchart of the system;

FIG. 3b displays a subset of FIG. 3a showing how the system uses constraints;

FIG. 4 displays an example of constraint selection

FIG. 5 Displays a number of results for subsets of relaxed constraints; and

FIG. 6 Displays a Solution of new parametric search using subset of constraints.

### DETAILED DESCRIPTION

The preferred embodiment of the invention is a method and process for refining a search or calculation query with multiple constraints via the Internet. The search is initiated by an end-user at a client system (Client) and received by a server system or group of server systems (Server). The Server receives the search query that includes multiple constraints. The Server then responds to the query with data that meets these constraints. The client system then presents the end user with a number of new queries that the user may use to refine their search.

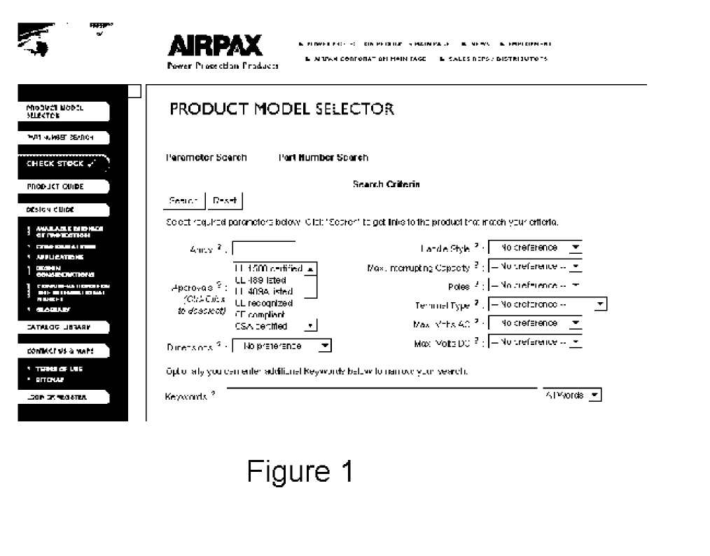

A computer application that includes the user interface for this invention will henceforth be referred to as “the System 1.” The System 1 is a search or calculation query with multiple constraints. FIG. 1 illustrates a functional diagram of a computer network for World Wide Web 500 access to the System 1 from a plurality of Users 10 who access the system Web Site 100 or the Users 10 can connect directly to the System 1. Accessing the System Web Site 100 can be accomplished directly through a communication means such as a direct connection, a intranet, a local Internet Service Provider, often referred to as ISPs, or through an on-line service provider like CompuServe, Prodigy, American Online, etc.

The Service Providers 20 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME or Linux, running a Web browser. The exact hardware configuration of computer used by the Service Providers 20, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

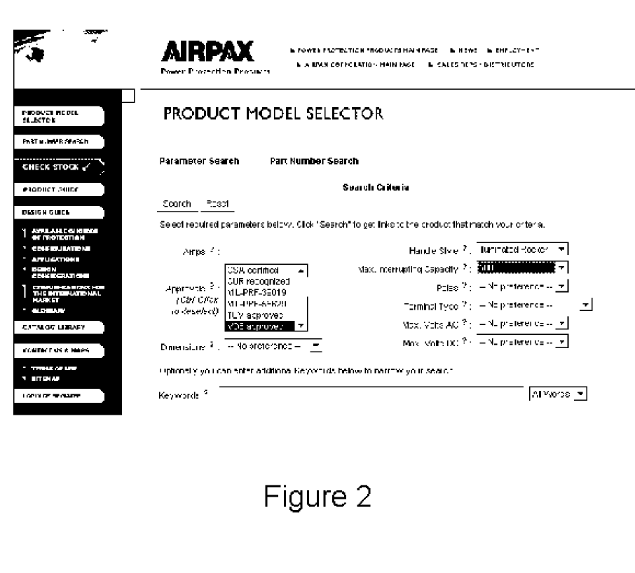

In one preferred embodiment of the invention, the Users 10 and/or Service Providers 20 connect to the System Web Site 100. FIG. 2 displays the Web Site 100 sample web page 200. In the preferred embodiment the system has numerous web pages. The information in the web pages are in HTML format via the HyperText Transport Protocol (http) and on Server System 310. The User System 110 includes software to allow viewing of web pages, commonly referred to as a Web Browser, such as Communicator available from Netscape Communications Corp. or Internet Explorer available from Microsoft Corp. The user system is capable of accessing web pages located on Server System 310.

Operations

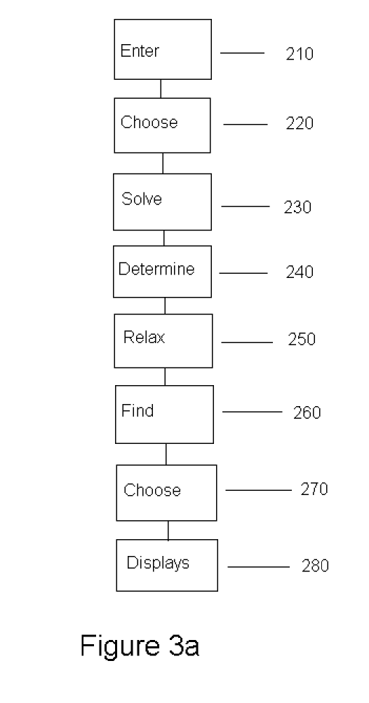

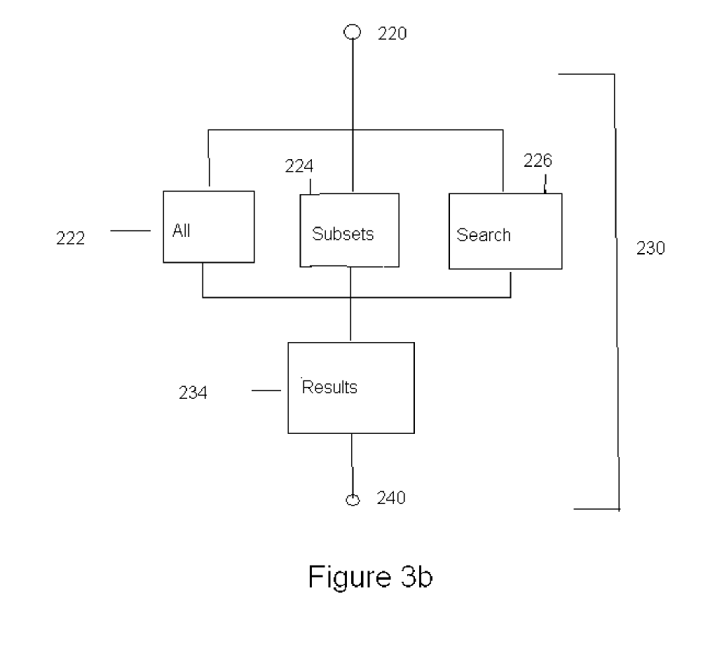

As shown in the flowchart in FIG. 3a, an end user 10 would like to perform a search, product configuration or problem where there are a number of constraints. For ease of description the process has been divided into eight steps.

As shown in Step 1 (210), the user 10 is presented with an interface to enter parameters for the problem constraints. For example these parameters may be: Entered as text or numbers, chosen from dialog boxes or pick list, chosen via radio buttons, color cubes or any other entering method. FIG. 2 is an example of end user screen for a “parametric search” for magnetic circuit breakers.

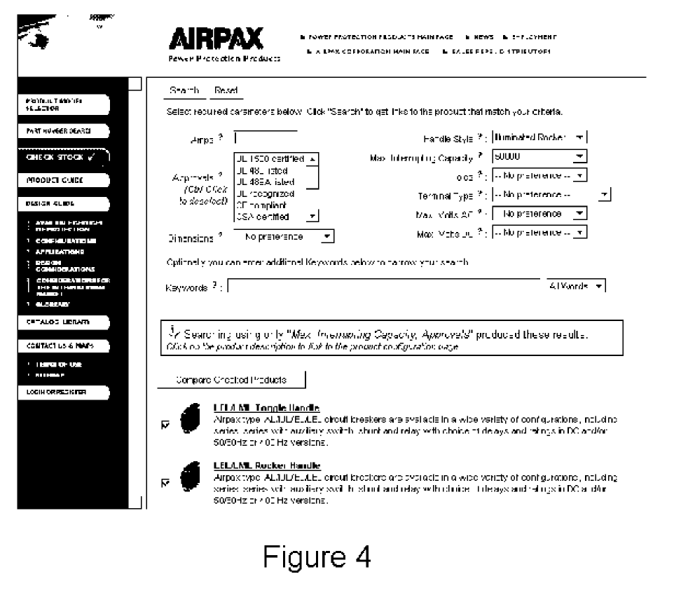

As show in Step 2 (220), the end user 10 chooses or enters one or more constraints for the problem. As shown in FIG. 4 the end users 10 have chosen the following constraints for their parametric search: Approval: VDE Approved, Handle Style: Illuminated Rocker, and Max Interrupting Capacity: 50,000. In this case by default the end user 10 has selected “no preference” for the other constraints.

In Step 3 (230), the system 1 attempts to solve the problem using the constraints as specified by the end user 10. As shown in FIG. 3b, the system 1 may calculate this solution in a number of ways: a) The system could solve for the problem simultaneously using all constraints (222) b) The system may first solve for solutions using subsets of the constraints and keep intermediate results for checking vie a vie remaining constraints. (224) c) The system may “search” for valid solutions using sampling, heuristinc, genetic or other non-deterministic algorithms. (226).

In Step 4 (240), based on preset conditions or results from step 3 (230) the system 1 will determine whether or not to present results using this method for relaxing constraints and then presenting the results. As shown in FIG. 4, the system 1 chooses to present the results in the relaxed constraints format when there are 0 results that meet all original end user constraints. Some example criteria that could be used for deciding to use the method is: 0 results (to give a user options), Less than X results (to give a user options), Always (to give a user an understanding of problem sensitivities), and based on “preset criteria (for example when the price of the solution is greater than a value the provider would like for the end user to see.)

In Step 5 (250), the system 1 creates one or more new sets of relaxed constraints from the first set. These new constraints may be determined by a number of methods such as: All subsets of constraints where one constraint is “no preference”, All subsets where 2 or more constraints are “no preference”, Similar subsets of constraints where the one or more of the constraints have been relaxed by a calculation or rule, and combination of the above techniques Several examples of rules or calculations for relaxing constraints are as follows. For a calculation take as an example the charts here for circuit breakers. A new constraint for lowering the max interrupting capacity may be to subtract 10,000 volts. Or, for example in a keyword search, synonyms and phonemes may be used in addition to the original text.

In Step 6 (260), the system 1 then finds the viable solutions using the relaxed sets of constraints. This may be done from scratch using the new sets of constraints or it may be done using intermediate results. For example in Step 234 the system 1 creates intermediate results where each solution set has first been calculated relaxing subsets of the constraints. These results are now available and applicable to the finding solutions to the new sets of constraints and speed the calculation.

In Step 7 (270), the system 1 chooses the subset constraints to display to the end user 10. In the preferred embodiment, this may be based on either the types of solutions, number of solutions or predetermined rules.

In Step 8 (280), the system 1 displays these sets of new constraints to the end users with relevant statistics such as: number of solutions found using the subset of constraints, maximum price, performance etc . . . for the solutions found for that set, and availability. This provides a method for the end user 10 to quickly review the associated results.

FIG. 4 displays an example of constraint selection.

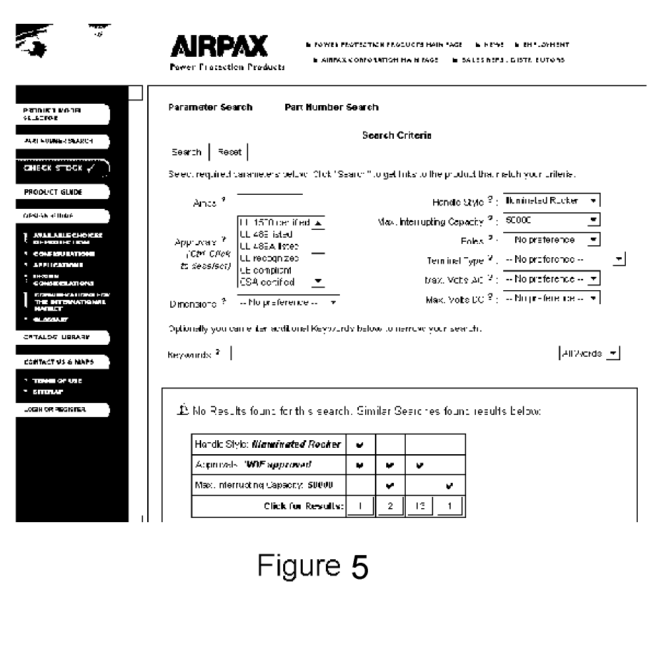

In the example in FIG. 5, the system 1 returns results for 4 subsets of relaxed constraints. The system returns the number of solutions for each associated subset of the constraints. And the system provides a method for viewing the associated solutions.

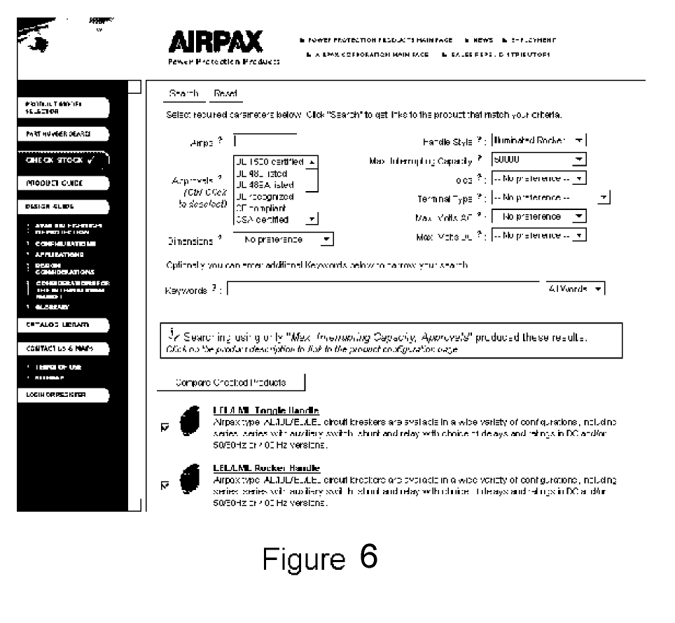

In FIG. 6 the end user 10 has clicked on the “2” results associated with just the constraint of VDE approved and Max Interrupting capacity of 50,000 volts.

The system 1 will be written using programming languages, techniques and knowledge that is commonly known in the art.

Advantages

The previously described version of the present invention has many advantages. The system gives users results in a format that makes it easier to analyze and with minimal work, refine the search query.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system performing a search query comprising:
having user choose a first group of constraints; ???????
having the user choose additional constraints;
searching based on the first group of constraints;
reviewing results of said search;
determining whether or not to search using said additional constraints;
having if it is determined searching based on additional constraints; and
providing the results of said search.

2. A system according to claim 1 in which includes having said user access the system using the Internet.

3. A system according to claim 1 in which includes having said user access the system through a client-server relationship.

4. A system according to claim 1 in which includes having said user enter constraint using an entry means.

5. A system according to claim 4 in which having said entry means is entering text.

6. A system according to claim 4 in which having said entry means is a dialog box.

7. A system according to claim 4 in which having said entry means is a pick list.

8. A system according to claim 4 in which having said entry means is radio buttons.

9. A system according to claim 1 in which includes having said system search using all said first constraints and additional constraints.

10. A system according to claim 1 in which includes having said system search using subsets of said constraints, keeping intermediate results and checking the remaining constraints if needed.

11. A system according to claim 1 in which includes having said system search using one or more of a set of sampling, heuristinc, genetic or other non-deterministic algorithm.

12. A system according to claim 1 in which includes relaxing, tightening or modifying the constraints before reporting said results.

13. A system according to claim 1 in which includes using new constraints.

14. A system according to claim 13 in which includes display said new constraints.

15. A system according to claim 1 in which includes returning the number of solutions for each subset of constraints.
